(19) United States
(12) Patent Application Publication
(10) Pub. No.: US 2020/0204570 A1
(43) Pub. Date: Jun. 25, 2020

(54) PROTECTION AGAINST OBSOLETE FILE FORMATS

(71) Applicant: Fortinet, Inc., Sunnyvale, CA (US)

(72) Inventors: Kushal Arvind Shah, Sunnyvale, CA (US); Peixue Li, Cupertino, CA (US)

(73) Assignee: Fortinet, Inc., Sunnyvale, CA (US)

(21) Appl. No.: 16/227,098

(22) Filed: Dec. 20, 2018

(51) Int. Cl. H04L 29/06; G06F 21/56; G06F 16/11

(52) U.S. Cl. CPC H04L 63/1416; H04L 63/145; G06F 21/565; G06F 2221/034; G06F 16/116; G06F 21/568; G06F 21/561

(57) ABSTRACT

Systems and methods are provided for mitigating obsolete file format based attacks. In one embodiment, a security device captures a file on a computer or to be transmitted to the computer. The security device checks the format of the file and determines whether the file format is obsolete. The security device takes an action on the file when the file format is determined to be obsolete.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2018, Fortinet, Inc.

### BACKGROUND

### Field

Embodiments of the present invention generally relate to the field of network security techniques. In particular, various embodiments relate to monitoring against suspicious obsolete file formats that can be attacked by malicious software.

### Description of the Related Art

With the developments of a software application, file formats that are used by the application may become more complicated over time, in order to support more functions. For example, the “.doc” file format was used by Microsoft Word from 1997-2003 and a new file format “.docx” was introduced when Microsoft Word 2007 was released. More file formats, such as “.dotx”, “.dotm” and “.docm”, have been introduced in new versions of Microsoft Word. With the increasing complexity of software, software developers may provide security patches to some popular file formats but may not continue to provide security patches for some obsolete file formats. In this context, an “obsolete file format” refers to an outdated or legacy file format that is still being supported by a particular software application. That is, files in obsolete file formats can still be opened and used by the corresponding applications, but they are no longer the primary file format or the current file format preferred for use with the corresponding applications, but rather are typically continued to be supported by newer versions of an applications for purposes of providing backwards compatibility with prior versions of the applications.

One problem with files in obsolete file formats is that as a result of unavailability of security patches these files may be insecure and may be vulnerable to attack by malicious entities. There are numerous zero-day attacks in which the attacker leverages the ongoing support for obsolete file formats. These attacks may be based on decades-old file formats. One general solution offered by security vendors is to check for malicious content inside a particular file, which when found, would be quarantined or deleted by the security solution. But, this existing solution does not secure the user against malformed files (of obsolete file formats) which when run by the software, could open more doors for a potential attacker via, for example, memory corruption-like vulnerabilities. Other malware detection mechanism, such as sandboxing, may be used for detecting whether the obsolete file formats are insecure before the files in obsolete file formats are transmitted to users. However, sandboxing typically takes more time and resources than simply scanning the content of a file.

Thus, there is a need for a security solution that can preemptively identify obsolete file formats as well as vulnerable components thereof and secure the end-user against legacy-leveraged zero-day attacks.

### SUMMARY

Systems and methods for mitigating obsolete file format based attacks are described. In one embodiment, a security device captures a file on a computer or to be transmitted to the computer. The security device checks the format of the file and determines whether the file format is obsolete. The security device takes an action on the file when the file format is determined to be obsolete.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a client machine configured with a client security module that is capable of mitigating obsolete file format based attacks in accordance with an embodiment of present invention.

FIG. 2 illustrates a browser configured with a security add-on that is capable of mitigating obsolete file format based attacks in accordance with an embodiment of present invention.

FIG. 3 illustrates an exemplary network architecture in which transmission of files having obsolete file formats is detected in accordance with an embodiment of the present invention.

FIG. 4 is a flow diagram illustrating a method for protecting users against legacy-leveraged attacks in accordance with an embodiment of the present invention.

FIG. 5 is a flow diagram illustrating a method for detecting a format of a file in accordance with an embodiment of the present invention.

FIG. 6 illustrates exemplary functional units of a security device that is capable of mitigating legacy-leveraged attacks in accordance with an embodiment of the present invention.

FIG. 7 is an exemplary computer system in which or with which embodiments of the present invention may be utilized.

### DETAILED DESCRIPTION

Systems and methods for mitigating obsolete file format based attacks are described. In one embodiment, a security device captures a file on a computer or to be transmitted to the computer. The security device checks the format of the file and determines whether the file format is obsolete. The security device takes an action on the file when the file format is determined to be obsolete.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The phrase “security device” generally refers to a hardware device or appliance configured to be coupled to a network and to provide one or more of data privacy, protection, encryption and security. The network security device can be a device providing one or more of the following features: network firewalling, VPN, antivirus, intrusion prevention (IPS), content filtering, data leak prevention, antispam, antispyware, logging, reputation-based protections, event correlation, network access control, vulnerability management, application control, load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORTIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

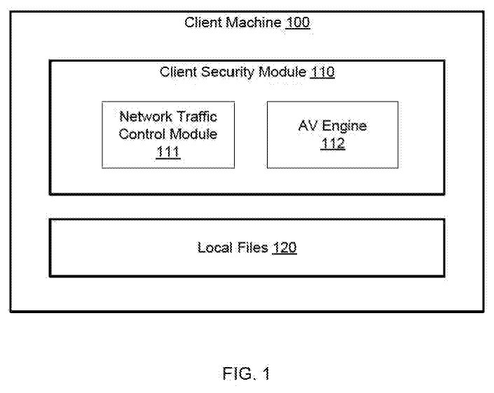

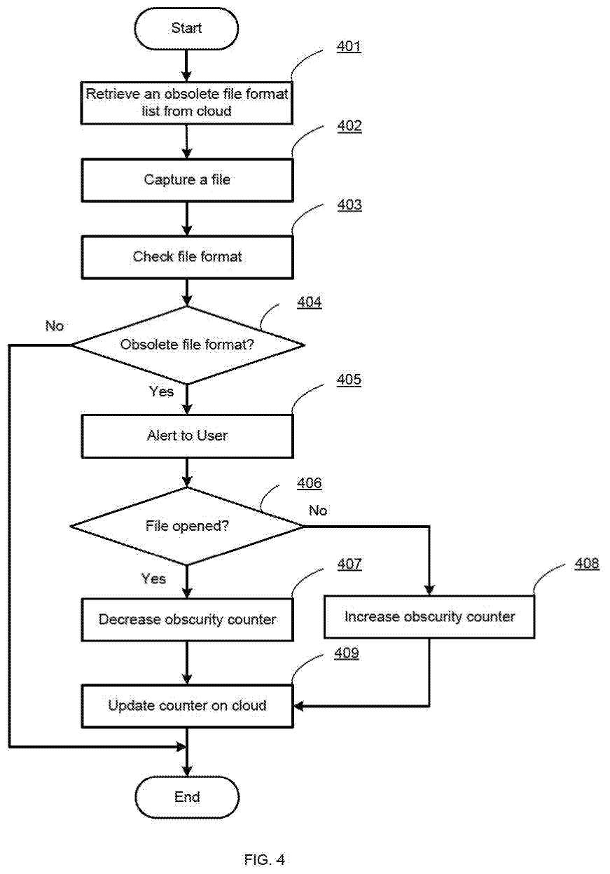

FIG. 1 illustrates a client machine 100 configured with a client security module 110 that is capable of mitigating obsolete file format based attacks in accordance with an embodiment of present invention. In this example, client machine 100 comprises client security module 110 and a client file system (not shown) that comprises local files 120. Client security module 110 may be a client security application, such the FORTICLIENT next generation endpoint protection platform, which is available from the assignee of the present invention. Client security module 110 comprises a network traffic control module 111 and an Antivirus (AV) engine 112. Network traffic control module 111 is used for intercepting network traffic going to client machine 100 and AV engine 112 is used for inspecting network traffic for viruses or malicious software. In the present example, AV engine 112 may collect a list of applications that are currently installed on client machine 100 by, for example, accessing the system registry (now shown). Then, AV engine 112 may fetch a list of obsolete file formats for each of the currently installed applications from a security service provider or cloud, such as the FORTICLOUD could-based management platform or the FORTIGUARD security subscription service available from the assignee of the present invention. Client security module 110 may run in the background and await files to be downloaded over a network or be transmitted by an email message. When a new file is captured by network traffic control module 111, a file format inspection engine (not shown) of AV engine 112 may detect the file format of the new file and check whether the file format is in the obsolete file format list. If the format of the file is an obsolete file format, a warning message may be shown to the user of client machine 100. The user may decide if the file should be accepted by opening or saving the file on client machine 100. The user's operation on this file format at client machine 100 may be counted and shared with the network security service provider to help the network security service provider to decide whether the file format is obsolete or not. In another example, AV engine 112 may also scan local files 120 periodically for obsolete file format and take an action on the files having obsolete file formats. The process of detecting obsolete file formats is described in detail below with reference to FIG. 4.

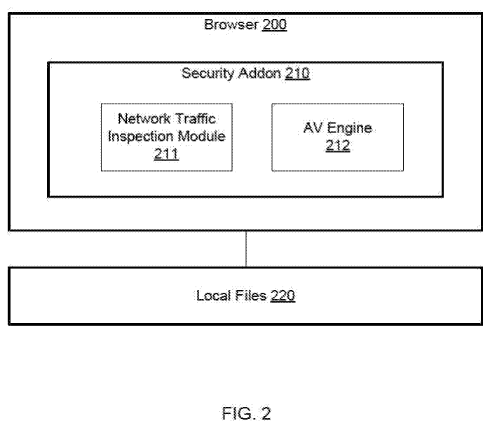

FIG. 2 illustrates a browser 200 that is configured with a security add-on 210 that is capable of mitigating obsolete file format based attacks in accordance with an embodiment of present invention. In this example, browser 200 is capable of accessing websites and downloading files from servers. Browser 200 comprises security add-on 210 that is capable of managing operations of browser 200 to protect the user from insecure operations. Security add-on 210 comprises a network traffic inspection module 211 and an AV engine 212. Network traffic inspection module 211 is capable of detecting network traffic transmitted to browser 200. Files downloaded by browser 200 are intercepted by network traffic inspection module 211 and are sent to AV engine 212 for inspection before the file is stored within local files 220. AV engine 212 is capable of detecting the file format of the downloaded file and determining whether the file format is an obsolete file format that can be exploited via vulnerable software. Responsive to the downloaded file being determined to be in an obsolete file format, network traffic inspection module 211 may block the file from being stored within local files 220 and prompt the user for further action.

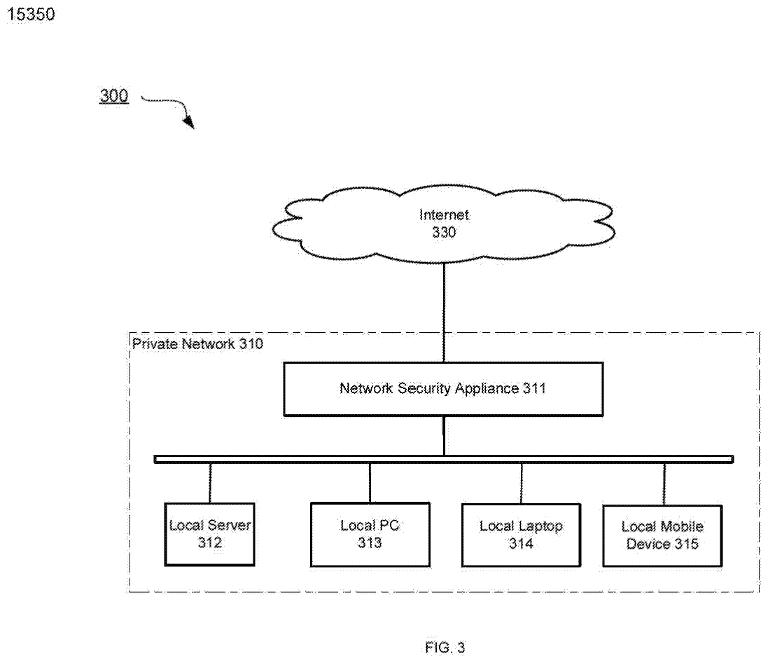

FIG. 3 illustrates an exemplary network architecture 300 in which transmission of files of obsolete file formats is detected in accordance with an embodiment of the present invention. Network architecture 300 comprises a private network 310 that is connected to a public network, such as the Internet 330. Private network 310 comprises multiple local computers, represented by local server 312, local PC 313, local laptop 314, local mobile device 315. A network security appliance 311 is used for separating the external computing environment, represented by Internet 330, from the internal computing environment of private network 310.

Network security appliance 311, such as a FORTIGATE next generation firewall available from the assignee of the present invention, may intercept the network traffic between Internet 330 and the local computers of private network 310 and may, among other things, scan the network traffic for malware, viruses or high risk network accesses. In the present example, network security appliance 311 may intercept files that are to be transmitted to local computers and determine whether the files are in obsolete file formats. Network security appliance 311 may take an action, such as blocking or quarantining the files in obsolete file formats in order to prevent the obsolete file formats from being exploited via vulnerable software on local computers and servers.

FIG. 4 is a flow diagram illustrating a method for mitigating obsolete file format based attacks in accordance with an embodiment of the present invention.

At block 401, a security device, such as client security module 110, security add-on 210 or network security appliance 311 mentioned above, may retrieve an obsolete file format list from a network security service provider or cloud. In one example, the network security service provider collects file formats that are used by popular applications and tracks whether the file formats are obsolete. For example, a developer of an application may announce that a file format that is used by the application is no longer supported and no further security patches will be issued for the obsolete file format. The obsolete file format may still be opened or used by the application but it may be insecure and susceptible to being exploited by vulnerable software. The network security provider may mark the file format as obsolete responsive to observing such an announcement. In another example, the network security service provider may track the date the file format was first launched or the date that the latest security patch for it was issued. If no security patch for this file format is issued for a predefined period, for example, ten years, the network security service provider may mark the file format as obsolete. In a further example, the network security service provider may track operations performed on a file format by end users over a private network or the Internet and determine whether the file format is obsolete or not based on the operations performed by the users. If most users behave in a manner consistent with the file format being obsolete (e.g., by refusing to open files of this format at their local computers), the security service provider may mark the file format as obsolete. By combining a large number of users' operations and file format information collected from the developers and/or the Internet, the network security service provider may maintain an obsolete file format list/database and share it with its users/subscribers.

In one example, when a client security application is installed on a client computer, the client security application may retrieve a list of applications that are installed on the client computer by, for example, scanning the system registry. The client security application may send the application list to the network security service provider and request the network security service provider to provide a list of obsolete file formats corresponding to the applications on the client computer. For example, the network security service provider may maintain a database that includes a large number of obsolete file formats that are collected from a large number of users. For a particular client computer, if the Microsoft Office family of software and some system applications are installed, the client security application may only download a corresponding obsolete file format list from the network security service provider for the installed applications and omit other obsolete file formats for other applications because these file formats cannot be opened directly by the client computer.

At block 402, the security device captures a file. In one example, the security device may intercept the file as it is attempted to be transmitted to a computer from network traffic directed to the computer. In another example, the security device may periodically scan the file system of the computer and check for obsolete files.

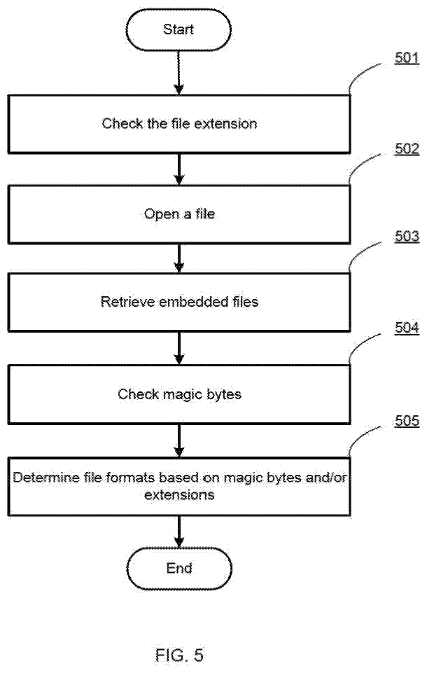

At block 403, the security device checks the format of the file captured at block 402. The file format of the file may be detected based on the extension of the file and/or by checking its magic bytes. If the file contains embedded file(s), the file format(s) of the embedded file(s) may also be detected. File format detection is described in further detail below with reference to FIG. 5.

At block 404, the security device checks whether the format of the file, as well as the format of embedded files, if any, are obsolete. For example, the security device may check if the file format is in an obsolete file format list that is retrieved from the network security service provider or maintained by the user of the local computer. If the file format is in the list, the security device may determine that the file format is obsolete. In another example, the security device may send the file format to the cloud or the network security service provider to detect if the file format is obsolete. Responsive to the request from the security device, the network security service provider may check the obsolete file format list and return the result (e.g., obsolete, not obsolete) to the security device.

When the file format is not obsolete, processing branches to the end and the security device takes no action, thereby allowing the file to be to be operated on as normal. When the file format is determined to be obsolete, processing continues with block 405.

At block 405, a message may be sent to the user of the file to warn the user that the file is in an obsolete file format and may be insecure for opening. Options for operations on the file, such as open, delete, quarantine or convert to a new format may also be provided together with the warning message.

At block 406, the security device may observe the action taken by the user. If the user ignores the warning message and opens the file, the security device may decrease an obscurity counter for this file format that is maintained at the local computer at block 407. If the user does not open the file after receiving the warning message, the security device may increase an obscurity counter for this file format at block 408.

At block 409, the security device may share the local obscurity counter for a file format with the network security service provider. The network security service provider may collect local obsolete counters for the same file format from a large number of users and accumulate the local obscurity counters together to make an online obsolete counter for the file format. If the online obsolete counter is over a predetermined threshold, the file format may be marked as obsolete and stored in the obsolete file format list, which may be shared with the users/subscribers.

FIG. 5 is a flow diagram illustrating a method for detecting a format of a file in accordance with an embodiment of the present invention.

At block 501, a security device may check an extension of a file to determine the file format or type. Usually, if the file extension is unique to a particular application, the file format of the file may be determined by its extension. However, it is possible that a file does not have an extension or the extension may be inconsistent with the file format. A file may also contain one or more embedded files. Thus, the security device may further check the contents of the file to determine file formats of the file itself as well as its embedded files.

At block 502, the security device may open the file and check whether there are ant embedded files at block 503. If there are one or more embedded files, the embedded files may be extracted for further checking.

At block 504, magic bytes of a file, that is the original file and any embedded file(s), are checked to determine the file format of the file. It is well known to those skilled in the art that some file formats have unique structures or file headers. The unique structures of a file, also called magic bytes, magic number or file signature, may be used to determine its file format.

At block 505, if the magic bytes of the file match with the magic bytes of a known file format, the file may be determined to be of this file format. In a situation in which the file extension is inconsistent with the file signature, the security device may send a warning message to the user.

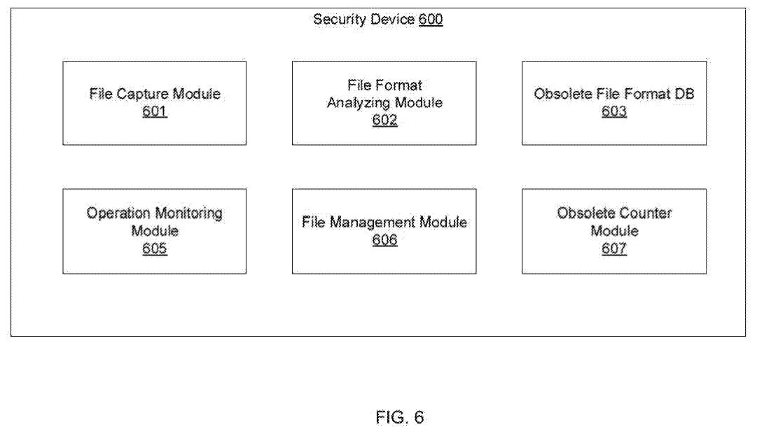

FIG. 6 illustrates exemplary functional units of a security device 600 that is capable of mitigating obsolete file format based attacks in accordance with an embodiment of the present invention. Non-limiting examples of security device 600 include those described with reference to FIGS. 1-5. In this example, security device 600 comprises a file capture module 601, a file format analyzing module 602, an obsolete file format DB 603, an operation monitoring module 605, a file management module 606, and an obsolete counter module 607.

File capture module 601, in one example, is used for intercepting new files that are received by a local computer over a private or public network. In another example, file capture module 601 is used for scanning existing files that have been stored in a computer for obsolete file formats.

Format analyzing module 602 is used for analyzing a format of a file based on its extension and/or magic bytes. Format analyzing module 602 may check if one or more embedded files are included in the file and analyze formats of embedded files if there are such embedded files in the original file.

Local obsolete file format DB 603 is used for storing obsolete file formats that may be insecure as a result of their susceptibility to being exploited by malware. Local obsolete file format DB 603 may be downloaded from a network security service provider that collects obsolete file format information from subscribers and/or software developers via the Internet, for example. Local obsolete file format DB 603 may also be updated periodically by subscribing to a obsolete file format DB maintained by the network security service provider.

File management module 606 may be used for checking whether a file format is obsolete. A file is determined to be of an obsolete file format when the file format of the file or a file format of embedded files, if any, are in local obsolete file format DB 603. Rather than maintaining local obsolete file format DB 603 or a supplemental check, file management module 606 may also check a file format online by requesting the network security service provider to determine whether the file format is obsolete or not with reference to the obsolete file format DB maintained by the network security service provider.

File management module 606 may take an action on the file based on a security policy of security device 600 based on the nature of the file format (e.g., obsolete or not obsolete). For example, the file may be blocked, deleted or quarantined if the obsolete file format is known to be dangerous to a user's computer. File management module 606 may also send a warning message to the user with options for further action to be take on the file.

Operation monitoring module 605 is used for monitoring the user's operation(s) on the file after the warning message is received by the user. For example, if the user ignores the warning message and opens the file as normal, operation monitoring module 605 may capture the fact that the file was opened and update an obsolete counter accordingly. When a file is opened by the end user, this is indicative of the file at issue not being obsolete. As such, operation monitoring module 607 may decrease an obsolete counter of a file format of a file that is opened by the end user. If the user refuses to open the file or deletes the file after receiving the warning message, obsolete counter module 607 may increase the obsolete counter for this file format. In this manner, the value of the obsolete counter of the file format may provide information regarding whether the file format is deemed as obsolete by the local user. Obsolete counter module 607 may send the local counters to the network security service provider to allow the network security service provider to accumulate the local obsolete counters among its subscriber base to derive an online obsolete counter for a file format. If an online obsolete counter of a file format is over a predetermined threshold, that is a large number of users refuse to open the file format, the network security service provider may determine that this file format should be deemed to be an obsolete file format.

If it is possible to convert an obsolete file format to a new version, file management module 606 may convert the file from the obsolete format to a new format responsive to a user request to do so.

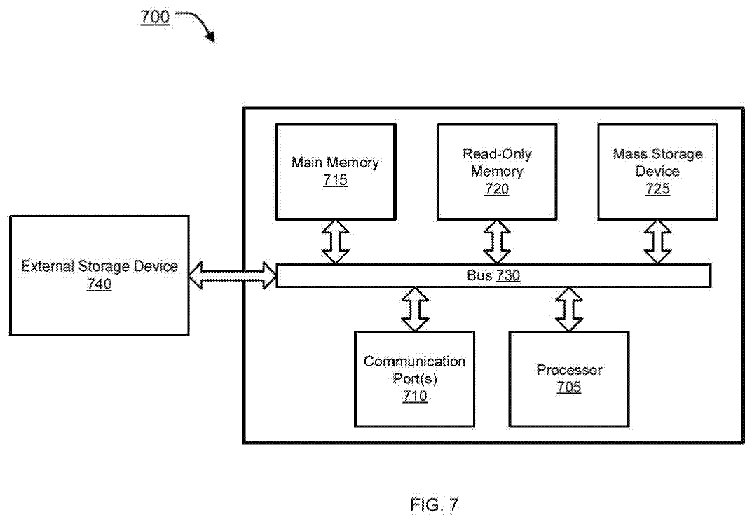

FIG. 7 is an example of a computer system 700 with which embodiments of the present disclosure may be utilized. Computer system 700 may represent or form a part of a network security device (e.g., security device 600) a network appliance (e.g., network security appliance 211), a server or a client workstation on which a client security module (e.g., client security module 110) or security add-on (e.g., security add-on 210) is running.

Embodiments of the present disclosure include various steps, which will be described in more detail below. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 700 includes a bus 730, a processor 705, communication port 710, a main memory 715, a removable storage media 740, a read only memory 720 and a mass storage device 725. A person skilled in the art will appreciate that computer system 700 may include more than one processor and communication ports.

Examples of processor 705 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 705 may include various modules associated with embodiments of the present invention.

Communication port 710 can be any of an RS-232 port for use with a modem based dialup connection, a 10/100 Ethernet port, a Gigabit or 10 Gigabit port using copper or fiber, a serial port, a parallel port, or other existing or future ports. Communication port 710 may be chosen depending on a network, such a Local Area Network (LAN), Wide Area Network (WAN), or any network to which computer system 700 connects.

Memory 715 can be Random Access Memory (RAM), or any other dynamic storage device commonly known in the art. Read only memory 720 can be any static storage device(s) such as, but not limited to, a Programmable Read Only Memory (PROM) chips for storing static information such as start-up or BIOS instructions for processor 705.

Mass storage 725 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 730 communicatively couples processor(s) 705 with the other memory, storage and communication blocks. Bus 730 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 705 to system memory.

Optionally, operator and administrative interfaces, such as a display, keyboard, and a cursor control device, may also be coupled to bus 730 to support direct operator interaction with computer system 700. Other operator and administrative interfaces can be provided through network connections connected through communication port 710.

Removable storage media 740 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
capturing, by a security device, a file on a computer or to be transmitted to the computer;
determining, by the security device, a file format of the file;
determining, by the security device, if the file format is an obsolete file format;
performing, by the security device, an action to the file if the file format is determined to be obsolete.

2. The method of claim 1, wherein the security device comprises an antivirus application running on the computer and the antivirus software scans directories of the computer and captures the file.

3. The method of claim 1, wherein the security device comprises a network security device that is capable of capturing network traffic of a network to which the computer is connected, wherein the file is intercepted by the network security device from network traffic going to the computer.

4. The method of claim 1, wherein the security device comprises an add-on to a browser.

5. The method of claim 1, wherein the file format of the file is determined based on an extension of the file.

6. The method of claim 1, wherein the security device checks the file structure and determines the file format of the file based on the file structure.

7. The method of claim 1, wherein the file structure includes a file header and/or magic bytes of the file.

8. The method of claim 1, further comprising:
determining, by the security device, if an embedded file exists in the file;
when an embedded file is determined to exist:
determining, by the security device, a file format of the embedded file; and
determining, by the security device, whether the file format of the embedded file is an obsolete file format;
responsive to determining the file format is the obsolete file format, performing, by the security device, an action on the file.

9. The method of claim 1, wherein said determining, by the security device, whether the file format is an obsolete file format further comprises one or more of
checking the file format in a local obsolete file format list; and
requesting a remote server to check if the file format is obsolete or not.

10. The method of claim 8, further comprising:
monitoring, by the security device, a user's action to the file format;
sending, by the security device, a counter of the user's action to the file format to a remote server that collects information of file formats.

11. The method of claim 1, wherein the action to the file includes one or more of sending a warning to a user of the computer;
quarantining the file in a quarantine area;
converting the file to a new format;
deleting the file; and
blocking the file from transmission on a network.
